(19) United States
(12) Patent Application Publication
(10) Pub. No.: US 2026/0320265 A1
(43) Pub. Date: Oct. 15, 2026

(54) Simulation system and simulation method

(71) Applicant: National Central University, Taoyuan City (TW)

(72) Inventors: Jui-Sheng Chen, New Taipei City (TW); Gour-Tsyh Yeh, Taoyuan City (TW); Yung-Yu Tai, Taoyuan City (TW); Yen-Pu Hsu, Taoyuan City (TW); Yin-Tung Kuo, New Taipei City (TW); Yu-Chieh Ho, Taichung City (TW); Zhong-Yi Liao, Taipei City (TW)

(21) Appl. No.: 19/180,096

(22) Filed: Apr. 15, 2025

(51) Int. Cl. G06F 30/28

(52) U.S. Cl. CPC G06F 30/28

(57) ABSTRACT

A simulation system operating in a computer system may include an import module, a mesh setting module, a parameter setting module and a computing module. The import module is used to import site hydrogeology information of a site. The mesh setting module is used to generate a geometry mesh of an area of interest of the site according to a node configuration and the site hydrogeology information. The parameter setting module is used to assign a simulation setting parameter for the geometry mesh. The computing module is used to compute a numerical simulation result for the area of interest according to the geometry mesh and the simulation setting parameter. A simulation method is realized through elements of the simulation system.

### BACKGROUND OF THE INVENTION

### 1. Field of the Invention

The invention is related to computational modeling techniques, in particular to a simulation system and a simulation method.

### 2. Description of the Prior Art

In field of environmental engineering, understanding of radioactive waste disposal, carbon dioxides (CO2) sequestration and/or enhanced geothermal systems within integrated subsurface media is a crucial task for environment improvement. However, such task involves modeling of interdependencies between multi-physics and multi-biogeochemistry within a multi-scale heterogeneous media, which is often complex and requires great computational resources.

Existing techniques often lack integrated capabilities to fully capture the interdependencies between various conditions during modeling of radioactive waste disposal, CO2 sequestration and/or enhanced geothermal systems in a real-time scenario, which may lead to inaccurate predictions in scenarios where rapid changes occur.

Therefore, there is an unmet need in the field to develop a simulation system and a simulation method to address the above issues.

### SUMMARY OF THE INVENTION

A simulation system operating in a computer system may include an import module, a mesh setting module, a parameter setting module and a computing module. The import module may be used to import site hydrogeology information of a site. The mesh setting module may be coupled with the import module and may be used to generate a geometry mesh of an area of interest of the site according to a node configuration and the site hydrogeology information. The parameter setting module may be coupled with the mesh setting module and may be used to assign a simulation setting parameter for the geometry mesh. The computing module may be coupled with the parameter setting module and may be used to compute a numerical simulation result for the area of interest according to the geometry mesh and the simulation setting parameter.

A simulation method may include an import module importing site hydrogeology information of a site, a mesh setting module generating a geometry mesh of an area of interest of the site according to a node configuration and the site hydrogeology information, a parameter setting module assigning a simulation setting parameter for the geometry mesh, and a computing module computing a numerical simulation result for the area of interest according to the geometry mesh and the simulation setting parameter.

These and other objectives of the present invention will no doubt become obvious to those of ordinary skill in the art after reading the following detailed description of the embodiments that is illustrated in the various figures and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustrative diagram of a simulation system according to at least one embodiment of the present disclosure.

FIG. 2 is a flow diagram of a simulation method performed by elements of the simulation system according to at least one embodiment of the present disclosure.

FIG. 3 is an illustrative diagram of an instance of site hydrogeology information of a site according to at least one embodiment of the present disclosure.

FIG. 4 is an illustrative diagram of an interface showing a node configuration for generating a geometry mesh regarding an area of interest according to at least one embodiment of the present disclosure.

FIG. 5 is an illustrative diagram of an interface showing an initial condition setting for the geometry mesh regarding an area of interest according to at least one embodiment of the present disclosure.

FIG. 6 is an illustrative diagram of an interface showing a boundary condition setting for the geometry mesh regarding an area of interest according to at least one embodiment of the present disclosure.

FIG. 7 is an illustrative diagram of an interface showing a process coupling setting for the geometry mesh regarding an area of interest according to at least one embodiment of the present disclosure.

FIG. 8 is a flow diagram of steps to compute a numerical simulation result for the area of interest according to the geometry mesh under the “loosely coupled setting” according to at least one embodiment of the present disclosure.

FIG. 9 is an illustrative diagram of simulation result of fluid movement in a steady state across the predetermined time period under the “loosely coupled setting” according to at least one embodiment of the present disclosure.

FIG. 10 is an illustrative diagram of simulation result of species transfer and reaction in a transient state cross the predetermined time period based on the steady state of the fluid movement according to at least one embodiment of the present disclosure.

FIG. 11 is an illustrative diagram of an interface showing a process coupling setting for the geometry mesh regarding an area of interest according to at least one embodiment of the present disclosure.

FIG. 12 is a flow diagram of steps to compute a numerical simulation result for the area of interest according to the geometry mesh according to at least one embodiment of the present disclosure.

FIG. 13 is an illustrative diagram of simulation result of fluid movement in a steady state across the predetermined time period under the “strongly coupled setting” according to at least one embodiment of the present disclosure.

FIG. 14 is an illustrative diagram of simulation result of species transfer and reaction in a transient state cross the predetermined time period based on the transient state of the fluid movement according to at least one embodiment of the present disclosure.

FIG. 15 is an illustrative diagram of simulation of phase distribution of fluid within a three-dimensional geometry mesh based on a strongly coupled setting of the fluid movement and the geo-mechanical deformation.

FIG. 16 is an illustrative diagram of simulation result of thermal transfer within a three-dimensional geometry mesh based on a strongly coupled setting of the fluid movement and thermal transfer.

FIG. 17 is an illustrative diagram of simulation result of stress variation within a three-dimensional geometry mesh based on a strongly coupled setting of the fluid movement and geo-mechanical deformation.

FIG. 18 is an illustrative diagram of numerical simulation result generated by the computing module being stored in ascii file format according to at least one embodiment of the present disclosure.

### DETAILED DESCRIPTION

The following descriptions of the embodiments illustrate implementations of the present disclosure, and those skilled in the art of the present disclosure can readily understand the advantages and effects of the present disclosure in accordance with the contents herein. However, the embodiments of the present disclosure are not intended to limit the scope of the present disclosure. The present disclosure can be practiced or applied by other alternative embodiments, and every detail included in the present disclosure can be changed or modified in accordance with different aspects and applications without departing from the essentiality of the present disclosure.

The features such as a ratio, structure, and dimension shown in drawings accompanied with the present disclosure are simply used to cooperate with the contents disclosed herein for those skilled in the art to read and understand the present disclosure, rather than to limit the scope of implementation of the present disclosure. Thus, in the case that does not affect the purpose of the present disclosure and the effect brought by the present disclosure, any change in proportional relationships, structural modification, or dimensional adjustment should fall within the scope of the technical contents disclosed herein.

As used herein, “comprising”, “including”, or “having” a specific element, unless otherwise specified, may include other elements such as components, ingredients, structures, regions, portions, devices, systems, steps, or connection relationships rather than exclude those elements.

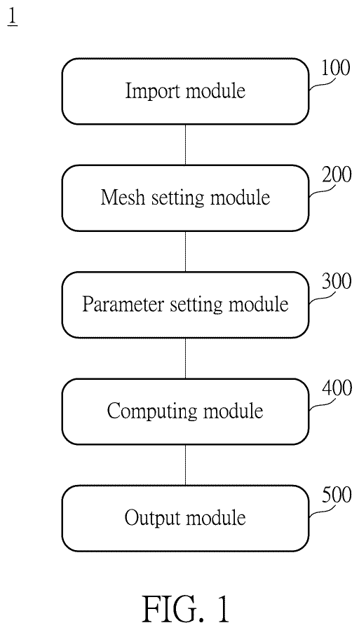

FIG. 1 is an illustrative diagram of a simulation system 1 having an import module 100, a mesh setting module 200 coupled with the import module 100, a parameter setting module 300 coupled with the mesh setting module 200, a computing module 400 coupled with the parameter setting module 300 and an output module 500 coupled with the computing module 400. The simulation system 1 may be operating in a computer system. The elements of the simulation system 1 may be coupled with each other via any appropriate wired or wireless manner. The simulation system 1 may be used to simulate any hydrological phenomena within a specified site, such as but not limited to radioactive waste disposal, carbon dioxides (CO2) sequestration and/or enhanced geothermal systems within the specified site, and is useful to assist in tasks such as site pollution estimation, site carbon dioxide storage estimation, geothermal field development, and/or other situations.

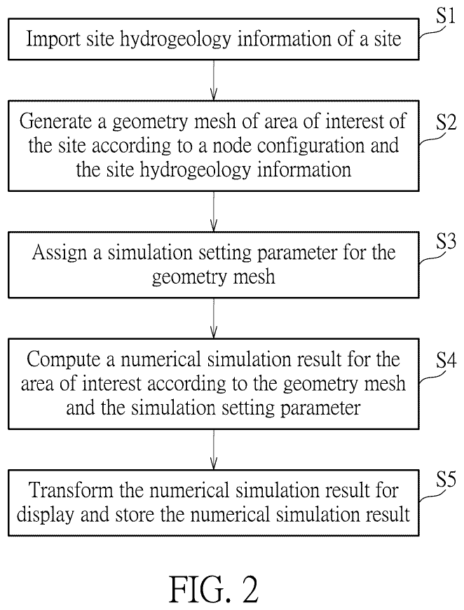

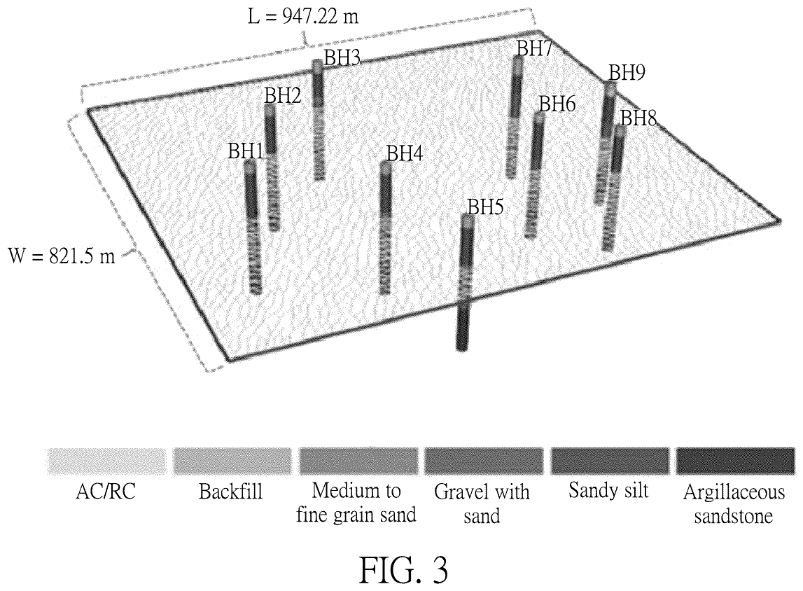

FIG. 2 is a flow diagram of a simulation method performed by elements of the simulation system 1. The operational details within steps S1 to S5 may be further understood through FIGS. 3 to 15.

At step S1, the import module 100 may be used to import site hydrogeology information of a site. The site hydrogeology information may include a shapefile of the site and/or borehole data within area of the site. For example, as shown in FIG. 3, the site hydrogeology information of the site may be a combination of a shape file and 9 pieces of borehole data (BH1, BH2, BH3, BH4, BH5, BH6, BH7, BH8 and BH9), where the shapefile of the site may be used to indicate the site having a rectangular shape with length being 947.22 m and width being 821.5 m, each piece of the borehole data may be used to indicate geological composition at the corresponding borehole by showing color blocks of different thickness (yellow for asphalt concrete/reinforced concrete (AC/RC), light green for backfill, mint green for medium to fine grain sand, turquoise for gravel with sand, denim color for sandy silt, and indigo for argillaceous sandstone), and the 9 pieces of borehole data within the area of the site, together, may be used to derive geological composition of the area of the site and variation of the geological composition within the area of the site. The site hydrogeology information may be imported from any appropriate open-sourced or closed-sourced geographic information system database, and may be used as reference for building geometry mesh for simulation and computation for simulation at later steps.

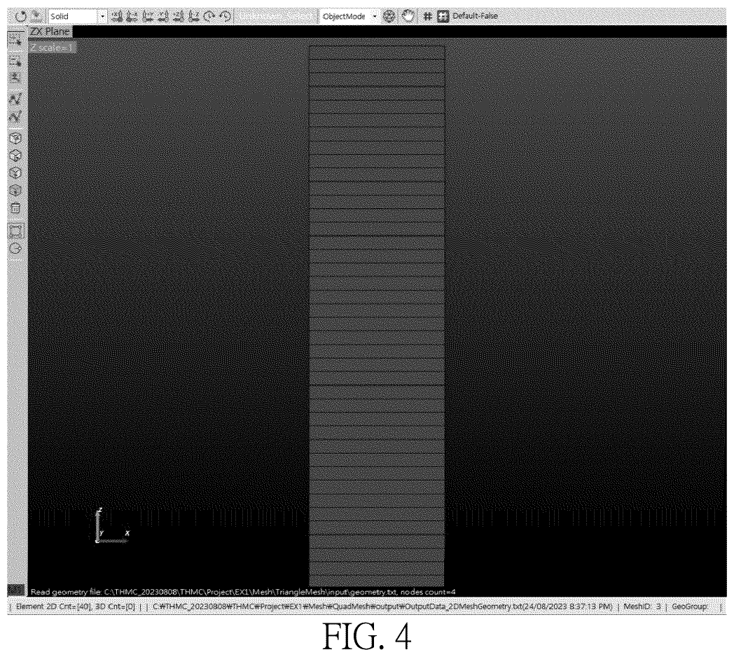

At step S2, the mesh setting module 200 may be used to generate a geometry mesh of an area of interest of the site according to a node configuration and the site hydrogeology information. In here, through an user interface (not shown), an user operating the simulation system 1 may designate an area of interest of the site for simulation, assign a node configuration of the geometry mesh corresponding to the area of interest, and have the mesh setting module 200 generate the geometry mesh of the area of interest of the site according to the node configuration and the site hydrogeology information. The area of interest may be located within the area of the site and may have a size smaller or equal to the size of the site. The area of interest may also have an arbitrary shape in a two-dimensional form or a three-dimensional form. The node configuration may include designated arrangements of nodes to generate the geometry mesh corresponding to the shape of the area of interest, including but not limited to: a designated number of nodes used to describe the shape of the area of interest, designated configuration of grids formed by the nodes to assemble the geometry mesh, a designated configuration of encrypted grids to cut down computation efforts, and/or a designated correlation between each of the nodes with the borehole data of the site hydrogeology information. The grids may be in shape of quadrilaterals, quadrilateral prisms, triangles, triangle prisms, tetrahedrons and/or a combination thereof. For example, as shown in FIG. 4, through the user interface, the user operating the simulation system 1 may designate the area of interest of the site to be a two-dimensional rectangular shape having width of 50 meters and length of 200 meters within the area of the site, assign the node configuration for the geometry mesh to be a set of quadrilateral grids formed by (41×2=82) nodes. The geometry mesh generated by the mesh setting module 200 may then be used as canvas for performing simulation thereon in later steps. Further, the borehole data correlated with the nodes may act as parameters for computing simulation in the later steps.

At step S3, the parameter setting module 300 may assign a simulation setting parameter for the geometry mesh generated by the mesh setting module 200. In here, the simulation setting parameter may include an initial condition setting, a boundary condition setting, and/or a process coupling setting for simulation. The simulation setting parameter may be input by the user operating the simulation system 1, or may be automatically extracted from the site hydrogeology information. The initial condition setting may define starting state of simulation within domain of the geometry mesh corresponding to the area of interest. The boundary condition setting may define environmental influences coming frown outside world towards the domain of the geometry mesh corresponding to the area of interest. The process coupling setting may define processes of material change within a predetermined time period for simulation within the domain of the geometry mesh, where the predetermined time period may consist of a number of time steps (i.e., a number of iterations for simulation), each of the time steps having a step size. Based on simulation requirements, each of the nodes in the geometry mesh may be assigned with an individual set of simulation setting parameters; or, a selected group of nodes in the geometry mesh may share a same set of simulation setting parameters.

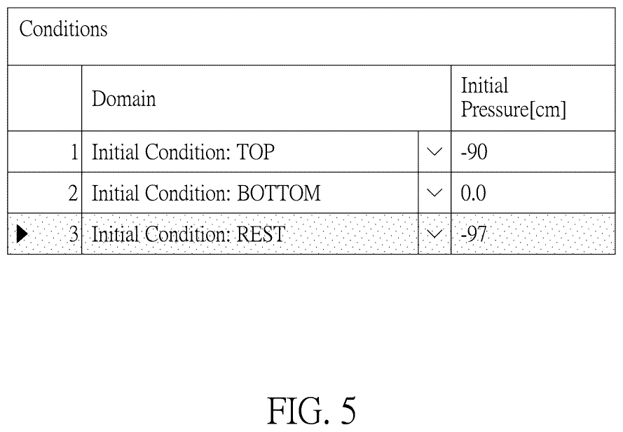

Initial condition setting may include settings of a pressure head within the domain of the geometry mesh. For example, as shown in FIG. 5, the initial condition setting for the geometry mesh may include the top portion of the geometry mesh having initial pressure head of −90 cm, the bottom portion of the geometry mesh having initial pressure head of 0 cm, and remaining areas (rest) of the geometry mesh having initial pressure head of −97 cm. In some examples, the initial condition setting may also include initial concentration of an existing species within the domain of the geometry mesh, an initial temperature within the domain of the geometry mesh, or other initial conditions regarding hydrogeology information within the domain of the geometry mesh.

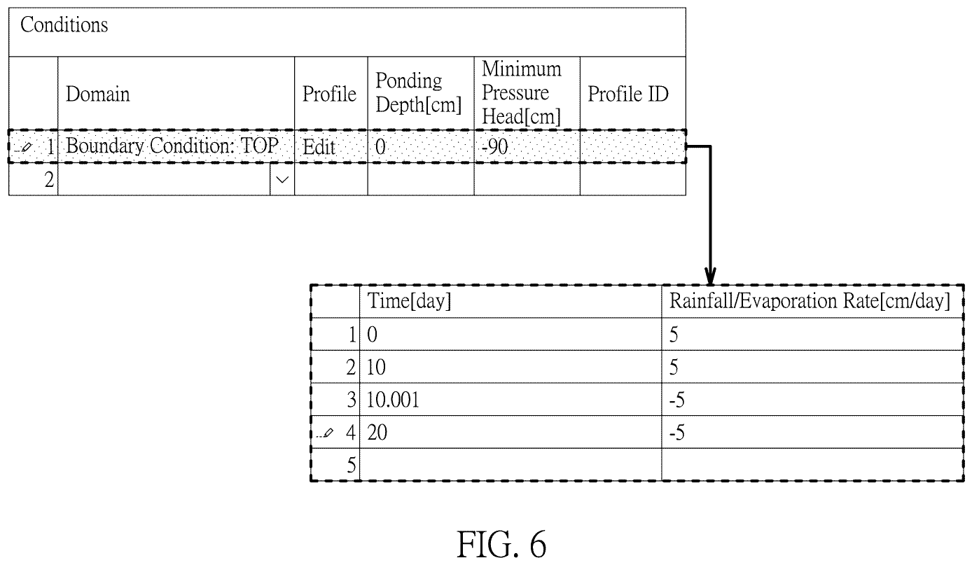

Boundary condition setting may include settings of rainfall, water evaporation, and/or ponding depth within the domain of the geometry mesh. For example, as shown in FIG. 6, the environmental influences of the top portion of the geometry mesh during simulation may include rainfall of 5 cm/day for a first ten days, a potential water evaporation of −5 cm/day for a second ten days, and a ponding depth of 0 cm.

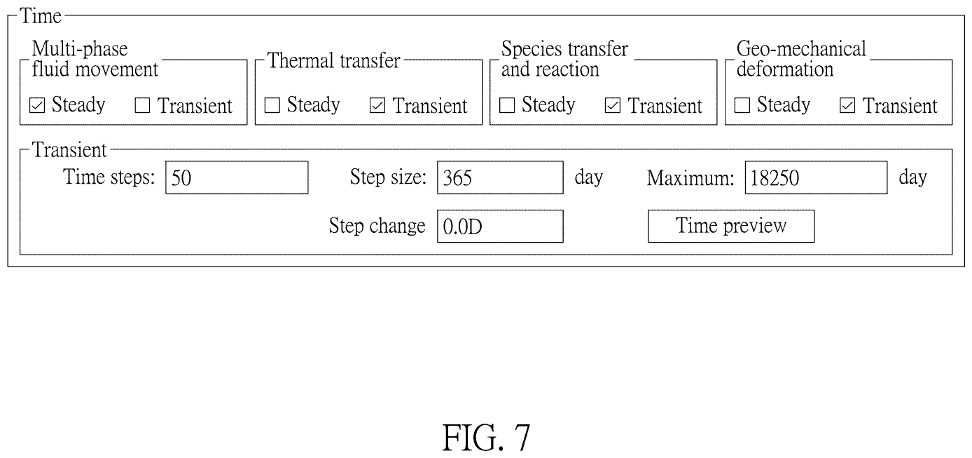

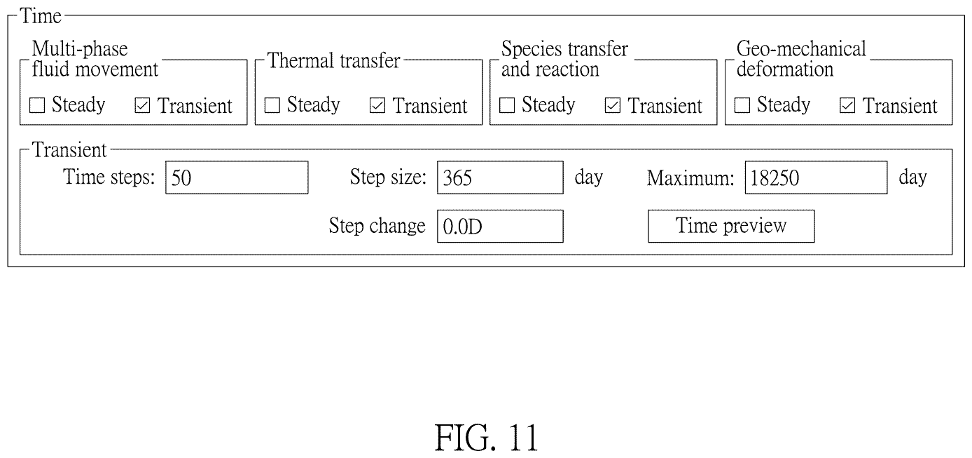

Process coupling setting may include a simulation setting for fluid movement, a simulation setting for thermal transfer, a simulation setting for species transfer and reaction, a simulation setting for geo-mechanical deformation and/or other simulation settings regarding interrelations between the above four processes of material change during the predetermined time period for simulation. For example, as shown in FIG. 7, the process coupling settings for the geometry mesh of FIG. 4 may include settings of the fluid movement being simulated under a steady state, settings of the thermal transfer being simulated under a transient state, settings of the species transfer and reaction being simulated under a transient state, settings of the geo-mechanical deformation being simulated under a transient state, settings of the predetermined time period for simulation spanning a maximum of 18,250 days, settings of a number of time steps for simulation being 50, and settings of each time step having a step size of 365 days. For another example shown in FIG. 11, the process coupling setting for the geometry mesh of FIG. 4 may include a simulation setting of fluid movement under a transient state, a simulation setting of thermal transfer under the transient state, a simulation setting of species transfer and reaction under the transient state, a simulation setting of geo-mechanical deformation under the transient state, settings of the predetermined time period for simulation spanning a maximum of 18,250 days, settings of a number of time steps for simulation being 50, and settings of each time step having a step size of 365 days. The process coupling setting of FIG. 7 may be referred as “loosely coupled setting,” the process coupling setting of FIG. 11 may be referred as “strongly coupled setting,” and the two process coupling setting may result in different simulation results at later steps. Moreover, other parameters associated with process coupling setting may be obtained through the site hydrogeology information and/or input from the user through the user interface, such as but not limited to dilation of the fluid within the domain of the geometry mesh, hydraulic conductivity of medium within domain of the geometry mesh, porosity of the medium within the domain of the geometry mesh, compressibility of the medium within the domain of the geometry mesh, water saturation level within the domain of the geometry mesh, fluid density within the domain of the geometry mesh, and/or fluid viscosity of the medium within the domain of the geometry mesh.

At step S4, the computing module 400 may compute a numerical simulation result for the area of interest according to the geometry mesh generated by the mesh setting module 200 and the simulation setting parameter set by the parameter setting module 300. Based on the process coupling setting of the simulation setting parameter being a “loosely coupled setting” or a “strongly coupled setting,” the step S4 may be performed in different manners, as will be explained in embodiment of FIGS. 7 to 10 and embodiment of FIGS. 11 to 14, respectively.

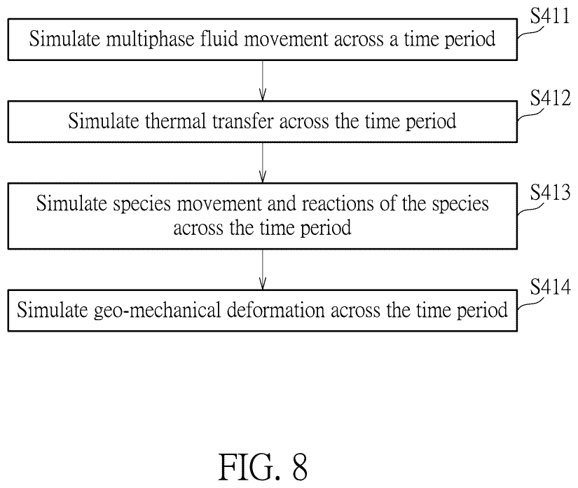

For a “loosely coupled setting,” the computing module 400 considers interrelations between fluid movement, thermal transfer, species transfer and reaction, and/or geo-mechanical deformation during simulation are insignificant. Based on the configurations shown in FIG. 7 as an example, the computing module 400 may compute the simulation of fluid movement, thermal transfer, species transfer and reaction, and geo-mechanical deformation within domain of the geometry mesh through steps S411 to S414 of FIG. 8.

At step S411, the computing module 400 may compute simulation of fluid movement across the predetermined time period. In here, Darcy's law and a continuity equation may be utilized by the computing module 400 to describe fluid movement under a steady state (as required in settings of FIG. 7). Computation under the Darcy's law may be used to derive a relationship between mass flux of the fluid transferring through porous medium in the domain of the geometry mesh. Computation under the continuity equation may be used to compute movement of the fluid within the domain of the geometry mesh based on conservation of mass between various phases of the fluids. Further, transport velocity characteristics and dispersion-diffusion characteristics of the fluid movement may also be derived from applying the Darcy's law and the continuity equation for computing the simulation of the fluid movement. For example, the derived transport velocity characteristics during the predetermined time period may include Darcy velocity of the fluid in a specified fluid phase during the predetermined time period, and/or other velocity-related variables of the fluid in a specified fluid phase during the predetermined time period; and the dispersion-diffusion characteristics may include longitudinal dispersivity of the fluid in the specified fluid phase during the predetermined time period, transverse dispersivity of the fluid in the specified fluid phase during the predetermined time period, hydrodynamic dispersion tensor of the fluid in the specified fluid phase during the predetermined time period, molecular diffusion coefficient of the fluid in the specified fluid phase during the predetermined time period, diffusion coefficient of accumulated normalized-effective saturation of the fluid in the specified fluid phase during the predetermined time period, and/or other dispersion-diffusion-related variables of the fluid in a specified fluid phase during the predetermined time period.

At step S412, the computing module 400 may compute simulation of thermal transfer across the predetermined time period. In here, the transport velocity characteristics of the fluid movement during the predetermined time period, the dispersion-diffusion characteristics of the fluid movement during the predetermined time period and an energy conservation principle may be utilized by the computing module 400 to describe thermal transfer in a transient state (as required in settings of FIG. 7). Computation under the energy conservation principle may be used to derive thermal behavior within the domain of the geometry mesh. In some embodiments, the thermal behavior may be derived as a function associated with thermal conductivity of the medium within the domain of the geometry mesh during the predetermined time period, thermal conductivity of the fluid in the specified fluid phase during the predetermined time period, thermal expansion coefficient of the medium within the domain of the geometry mesh during the predetermined time period, thermal expansion coefficient of the fluid in the specified fluid phase during the predetermined time period, thermal dispersion coefficient tensor of the fluid in the specified fluid phase during the predetermined time period, thermal diffusion coefficient tensor of the fluid in the specified fluid phase during the predetermined time period, and/or other thermal influences imposed on the medium within the domain of the geometry mesh during the predetermined time period.

At step S413, the computing module 400 may compute simulation of species transfer and reaction across the predetermined time period. In here, the transport velocity characteristics of the fluid movement, the dispersion-diffusion characteristics of the fluid movement, the thermal behavior of the thermal transfer and a mass conservation equation may be utilized by the computing module 400 to describe species transfer and reaction thereof in a transient state (as required in the settings of FIG. 7). Computation under the mass conservation equation may be used to derive dynamic of concentration change of a specified species within domain of the geometry mesh. In some embodiments, the dynamic of concentration change of a specified species may be derived as a function associated with reaction rate of the specified species during the predetermined time period, production rate of the specified species in the fluid of the specified fluid phase during the predetermined time period, mass production rate of the specified species in the fluid of the specified fluid phase during the predetermined time period, reaction stoichiometry of the species in the fluid of the specified fluid phase during the predetermined time period, and/or other reactions originated from the specified species within the domain of the geometry mesh during the predetermined time period.

At step S414, the computing module 400 may compute simulation of geo-mechanical deformation across the predetermined time period. In here, the transport velocity characteristics of the fluid movement, the dispersion-diffusion characteristics of the fluid movement, the thermal behavior of the thermal transfer and a mechanical equilibrium equation may be utilized to describe the geo-mechanical deformation in a transient state (as required in the settings of FIG. 7). Computation under the mechanical equilibrium equation may be used to derive displacement and deformation of medium within the domain of the geometry mesh. In some embodiments, the displacement and deformation of medium may be derived as a function associated with stress tensor exerting on the medium within the domain of the geometry mesh during the predetermined time period, external force imposing to the medium within the domain of the geometry mesh during the predetermined time period, and/or other physiological influences imposed on the medium within the domain of the geometry mesh during the predetermined time period.

In some embodiments, the steps S411 to S414 may be simulated concurrently through a finite element method. However, the simulation described in step S411 to S414 may also be realized through other means.

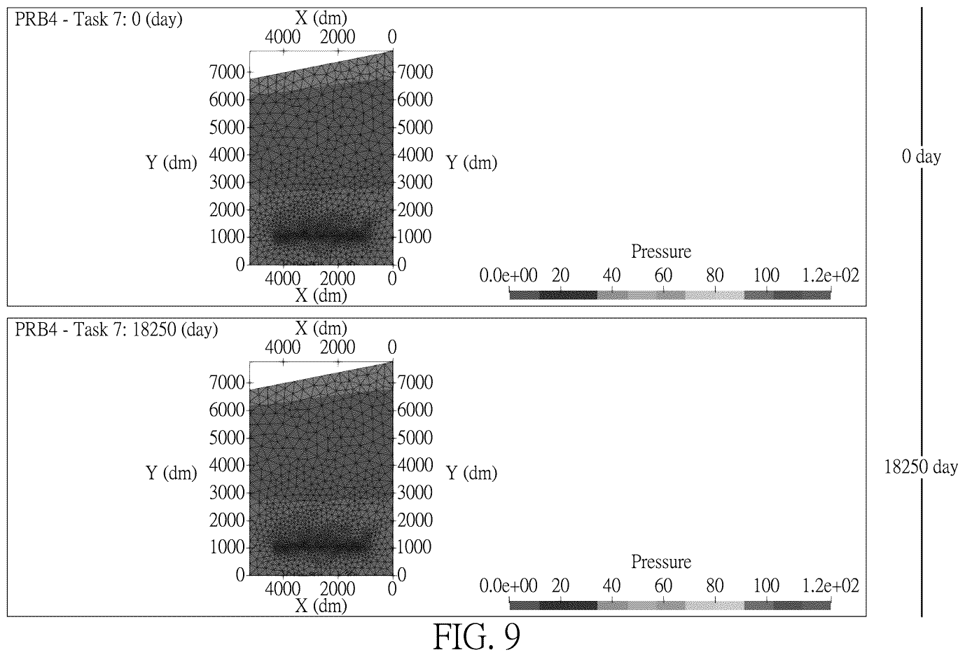

FIG. 9 is an illustrative diagram of simulation result of fluid movement in a steady state across the predetermined time period under the “loosely coupled setting”. Here, the fluid movement on day 0 (top picture of FIG. 9) of the predetermined time period is essentially the same as the fluid movement on day 18250 (bottom picture of FIG. 9) of the predetermined time period, where the fluid is transferred from top to bottom in a steady velocity. The phenomenon is contributed by the fluid movement being simulated under a steady state and the parameters initially set out in the simulation setting parameters for simulation remaining unchanged throughout the timeline of the predetermined time period.

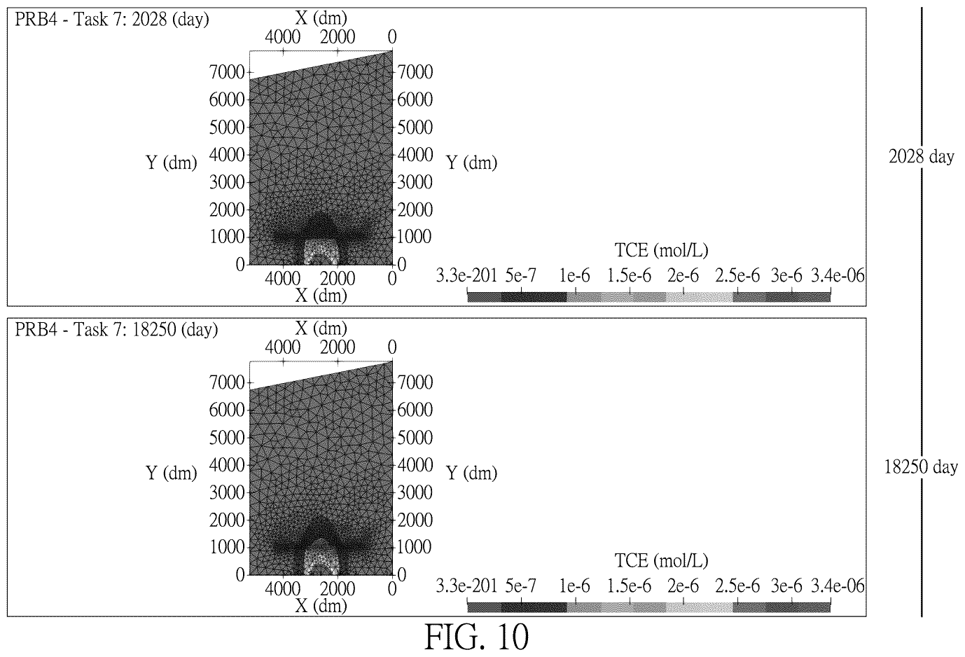

FIG. 10 is an illustrative diagram of simulation result of species transfer and reaction in a transient state cross the predetermined time period based on the steady state of the fluid movement of FIG. 9. Here, the species transfer and reaction presented on day 2028 (top picture of FIG. 10) of the predetermined time period is also essentially the same as the species transfer and reaction presented on day 18250 (bottom picture of FIG. 10) of the predetermined time period, where species are transferred from top to bottom according to the steady velocity of the fluid.

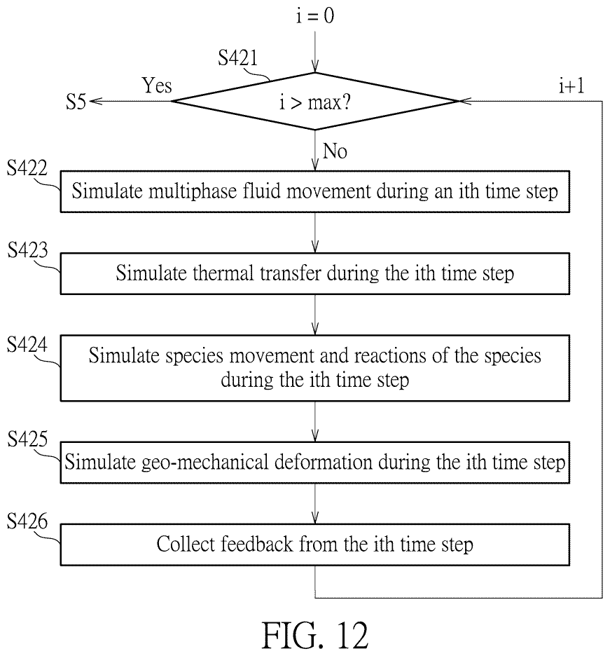

For a “strongly coupled setting,” the computing module 400 considers interrelations between fluid movement, thermal transfer, species transfer and reaction, and/or geo-mechanical deformation during simulation are significant, and parameters initially set out in the simulation setting parameters for simulation may be altered throughout the timeline of the predetermined time period due to influence by the four processes in each time step. Using the configurations shown in FIG. 11 as an example, the computing module 400 may compute the simulation of fluid movement, thermal transfer, species transfer and reaction, and geo-mechanical deformation within domain of the geometry mesh during the length of time indicated by the step size using steps S421 to S426 of FIG. 12, one time step at a time. In here, step S4 is started by computing a simulation result at (0)th time step of the predetermined time period.

At step S421, the computing module 400 may determine if a current (i)th time step has reached the last time step (e.g., i may be 50, which is max value of i) of the predetermined time period. When the value of i has yet to exceed the max value, step S422 may proceed for further computation. If the value of i has exceeded the max value, step S5 may proceed.

At step S422, the computing module 400 may compute simulation of fluid movement during the (i)th time step. In here, Darcy's law and a continuity equation may be utilized by the computing module 400 to describe fluid movement during the (i)th time step. Computation under the Darcy's law may be used to derive a relationship between mass flux of the fluid transferring through porous medium in the domain of the geometry mesh during the (i)th time step. Computation under the continuity equation may be used to compute movement of the fluid within the domain of the geometry mesh during the (i)th time step based on conservation of mass between various phases of the fluids. Further, transport velocity characteristics and dispersion-diffusion characteristics of the fluid movement during the (i)th time step may also be derived from applying the Darcy's law and the continuity equation for computing the simulation of the fluid movement. For example, the derived transport velocity characteristics may include Darcy velocity of the fluid in a specified fluid phase during the (i)th time step, and/or other velocity related variants of the fluid during the (i)th time step; and the dispersion-diffusion characteristics may include longitudinal dispersivity of the fluid in the specified fluid phase during the (i)th time step, transverse dispersivity of the fluid in the specified fluid phase during the (i)th time step, hydrodynamic dispersion tensor of the fluid in the specified fluid phase during the (i)th time step, molecular diffusion coefficient of the fluid in the specified fluid phase during the (i)th time step, diffusion coefficient of accumulated normalized-effective saturation of the fluid in the specified fluid phase during the (i)th time step, and/or other dispersion-diffusion-related variables of the fluid during the (i)th time step.

At step S423, the computing module 400 may compute simulation of thermal transfer during the (i)th time step. In here, the transport velocity characteristics of the fluid movement during the (i)th time step, the dispersion-diffusion characteristics of the fluid movement during the (i)th time step and an energy conservation principle may be utilized by the computing module 400 to describe thermal transfer during the (i)th time step. Computation under the energy conservation principle may be used to derive thermal behavior within the domain of the geometry mesh during the (i)th time step. In some embodiments, the thermal behavior during the (i)th time step may be derived as a function associated with thermal conductivity of the medium within the domain of the geometry mesh during the (i)th time step, thermal conductivity of the fluid in the specified fluid phase during the (i)th time step, thermal expansion coefficient of the medium within the domain of the geometry mesh during the (i)th time step, thermal expansion coefficient of the fluid in the specified fluid phase during the (i)th time step, thermal dispersion coefficient tensor of the fluid in the specified fluid phase during the (i)th time step, thermal diffusion coefficient tensor of the fluid in the specified fluid phase during the (i)th time step, and/or other thermal influences imposed on the medium within the domain of the geometry mesh during the (i)th time step.

At step S424, the computing module 400 may compute simulation of species transfer and reaction during the (i)th time step. In here, the transport velocity characteristics of the fluid movement during the (i)th time step, the dispersion-diffusion characteristics of the fluid movement during the (i)th time step, the thermal behavior of the thermal transfer during the (i)th time step and a mass conservation equation may be utilized by the computing module 400 to describe species transfer and reaction thereof during the (i)th time step. Computation under the mass conservation equation may be used to derive dynamic of concentration change of a specified species during the (i)th time step within the domain of the geometry mesh. In some embodiments, the dynamic of concentration change of a specified species during the (i)th time step may be derived as a function associated with reaction rate of the specified species, production rate of the specified species in the fluid of the specified fluid phase, mass production rate of the specified species in the fluid of the specified fluid phase, reaction stoichiometry of the species in the fluid of the specified fluid phase, and/or other reaction originated from the specified species within the domain of the geometry mesh during the (i)th time step.

At step S425, the computing module 400 may compute simulation of geo-mechanical deformation during the (i)th time step. In here, the transport velocity characteristics of the fluid movement during the (i)th time step, the dispersion-diffusion characteristics of the fluid movement during the (i)th time step, the thermal behavior of the thermal transfer during the (i)th time step and a mechanical equilibrium equation may be utilized to describe the geo-mechanical deformation during the (i)th time step. Computation under the mechanical equilibrium equation may be used to derive displacement and deformation of medium within the domain of the geometry mesh during the (i)th time step. In some embodiments, the displacement and deformation of medium may be derived as a function associated with stress tensor exerting on the medium within the domain of the geometry mesh during the (i)th time step, external force imposing to the medium within the domain of the geometry mesh during the (i)th time step, and/or other physiological influences imposed on the medium within the domain of the geometry mesh during the (i)th time step.

At step S426, the computing module 400 may generate feedback from computing simulation of the fluid movement, the thermal transfer, the species transfer and reaction, and the geo-mechanical deformation during the (i)th time step. The feedback may be used to update parameters set out in the simulation setting parameters for simulation during the next (i.e. (i+1)th) time step. In some embodiments, given consideration that fluid viscosity and fluid density of the fluid in the specified fluid phase are influenced by the thermal behavior, the computing module 400 thus may generate feedback based on the thermal behavior during the (i)th time step to alter the fluid viscosity of the fluid in the specified fluid phase and the fluid density in the specified fluid phase for simulation of the fluid movement during the next (i.e. (i+1)th) time step. In some embodiments, given consideration that mass of the fluid in the specified fluid phase is influenced by change of mass of the specified species in the fluid of the specified fluid phase, the computing module 400 thus may generate feedback based on the dynamic of concentration change of the specified species during the (i)th time step to consider the production rate of the specified species in the fluid of the specified fluid phase for simulation of the fluid movement during the next (i.e. (i+1)th) time step. In some embodiments, given consideration that dilation of the fluid within the domain of the geometry mesh is influenced by geo-mechanical deformation, the computing module 400 thus may generate feedback based on the displacement and the deformation of the medium within the domain of the geometry mesh during the (i)th time step to alter the dilation of the fluid within the domain of the geometry mesh for simulation of the fluid movement during the next (i.e. (i+1)th) time step.

After feedback is generated, the computing module 400 may repeat steps S421 to S426 and compute the simulation of fluid movement, thermal transfer, species transfer and reaction, and geo-mechanical deformation within domain of the geometry mesh for the next (i.e., (i+1)th) time step according to the feedback. Step 4 will be deemed completed until simulation result of fluid movement, thermal transfer, species transfer and reaction, and geo-mechanical deformation within domain of the geometry mesh for all time steps of the predetermined time period have been computed.

In some embodiments, the steps S421 to S426 may be simulated concurrently through a finite element method. However, the simulation described in step S421 to S426 may also be realized through other means.

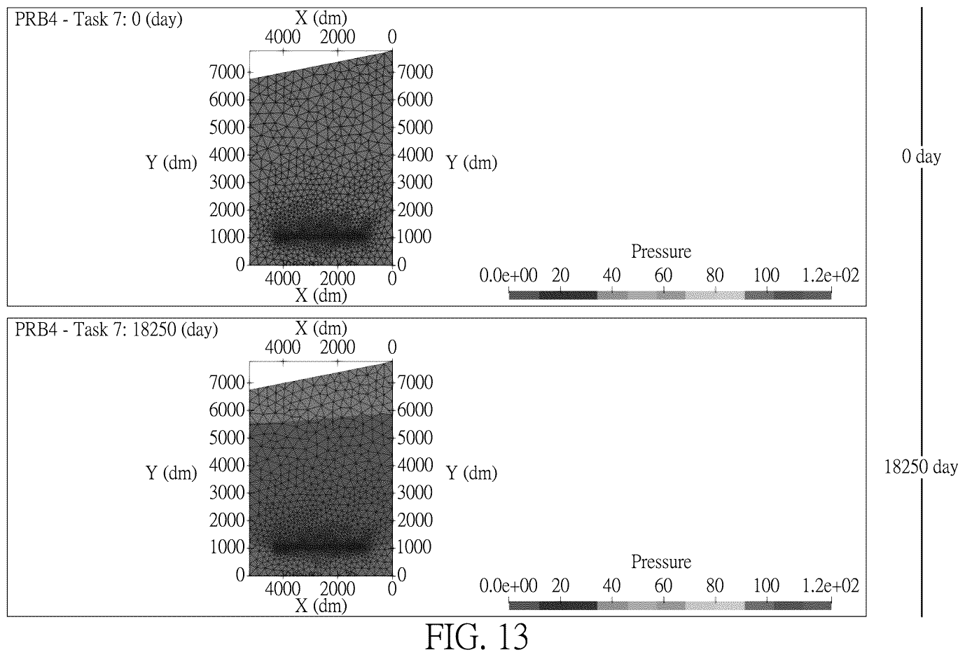

FIG. 13 is an illustrative diagram of simulation result of fluid movement in a transient state across the predetermined time period under the “strongly coupled setting”. Here, the fluid movement on day 0 (top picture of FIG. 13) of the predetermined time period and the fluid movement on day 18250 (bottom picture of FIG. 13) of the predetermined time period appears to have different pressure distribution, the predetermined time period and the fluid movement on day 18250 (bottom picture of FIG. 13) of the predetermined time period also appears to have yet to achieve a steady state. The phenomenon is contributed by the fluid movement being simulated under a transient state (as required in settings of FIG. 11) and the parameters initially set out in the simulation setting parameters for simulation are constantly changing due to influences of the four processes at each time step.

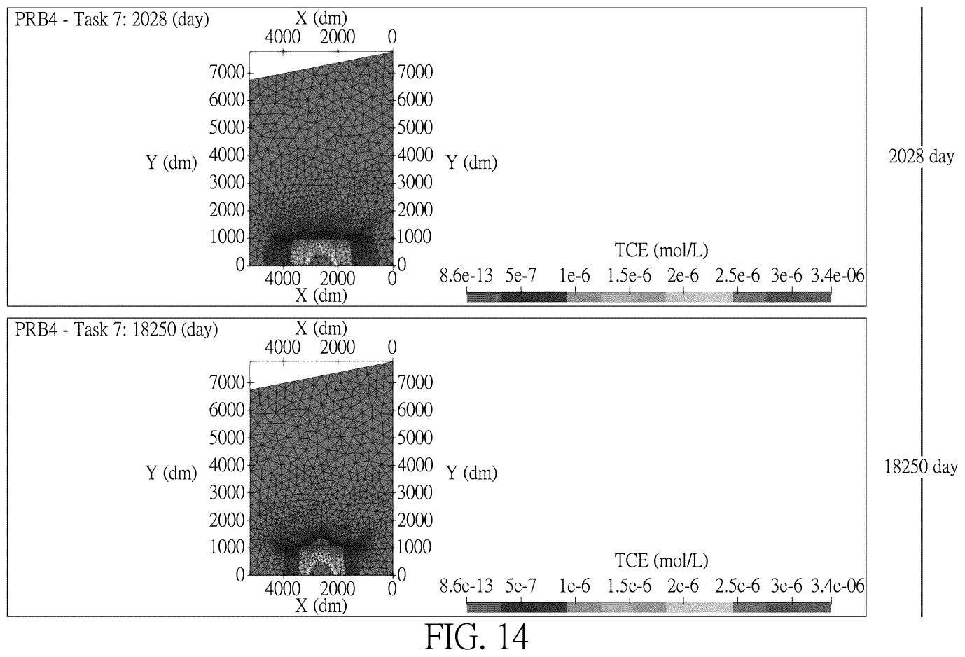

FIG. 14 is an illustrative diagram of simulation result of species transfer and reaction in a transient state cross the predetermined time period based on the transient state of the fluid movement of FIG. 13. Here, the species transferring within domain of the geometry mesh on day 2028 (top picture of FIG. 14) tends to spread transversely, while the species transferring within domain of the geometry mesh on day 18250 (bottom picture of FIG. 14) tends to spread longitudinally. This phenomenon is contributed by the fluid movement during each time step being different in a transient state.

In some other embodiments, the simulation result may also be presented in other formats to meet simulation objectives required by the user.

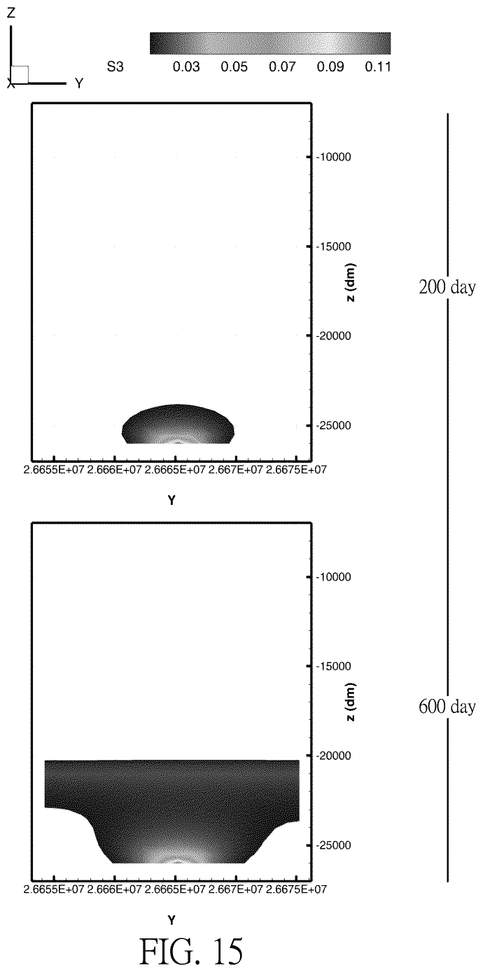

For example, FIG. 15 is an illustrative diagram of simulation result of phase distribution of fluid within a three-dimensional geometry mesh based on a strongly coupled setting of the fluid movement (which is a multi-phase fluid movement) and the geo-mechanical deformation, where migration of carbon dioxide stored within various phases of the multi-phase fluid within domain of the geometry mesh between day 200 (top picture) and day 600 (bottom picture) is shown, which may be used as reference for site carbon dioxide storage estimation.

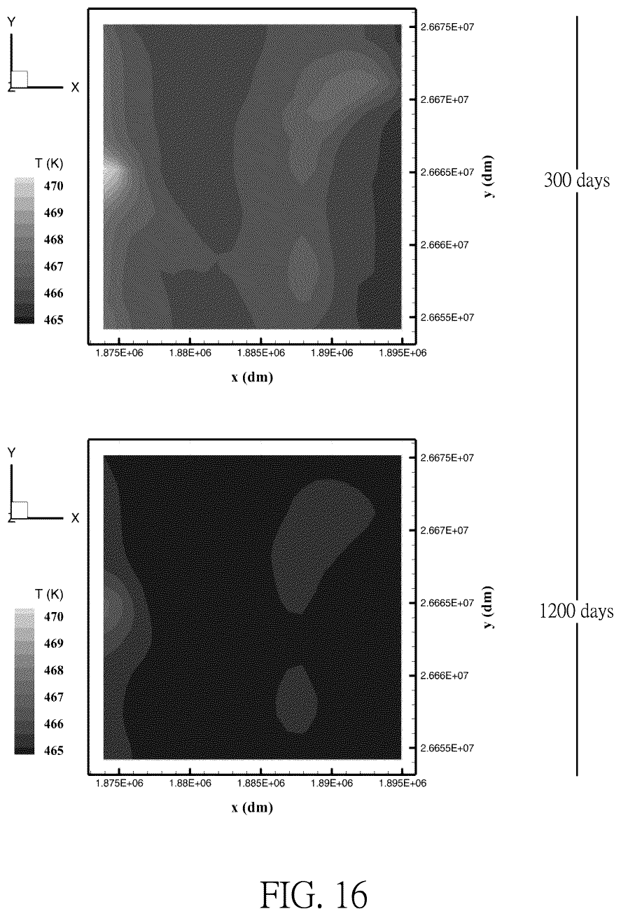

In another example, FIG. 16 is an illustrative diagram of simulation result of thermal transfer within a three-dimensional geometry mesh based on a strongly coupled setting of the fluid movement and thermal transfer, where isotherms at day 300 (top picture) and day 1200 (bottom picture) at a specified altitude of the geometry mesh is shown to represent temperature drop through time after being infected by water injection into domain of the geometry mesh, which may be used as reference for geothermal field development.

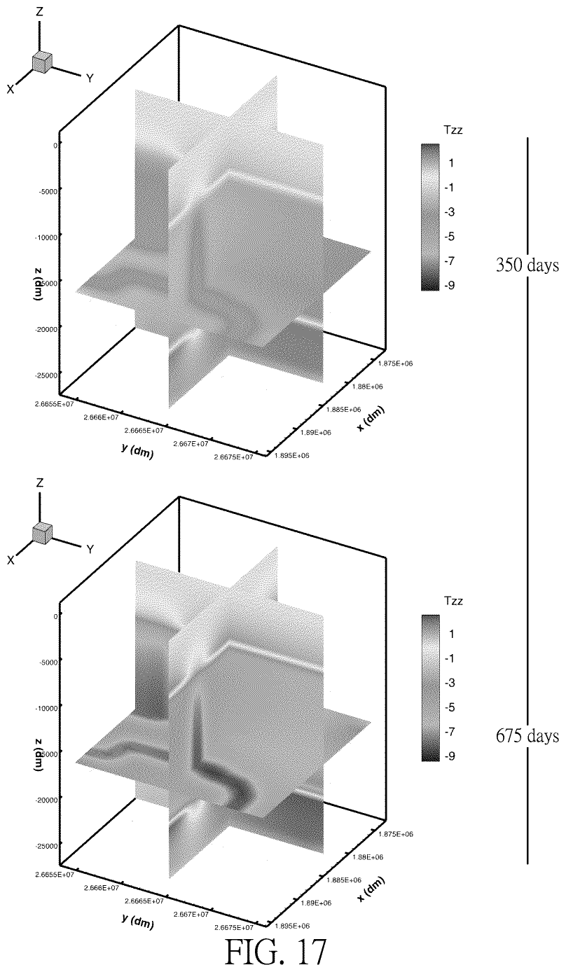

In a further example, FIG. 17 is an illustrative diagram of simulation result of stress variation within a three-dimensional geometry mesh based on a strongly coupled setting of the fluid movement and geo-mechanical deformation, where stress variations infected by water injection between day 350 (top picture) and day 675 (bottom picture) may be shown on vertical direction within domain of the geometry mesh, which may be used as reference for geothermal field development.

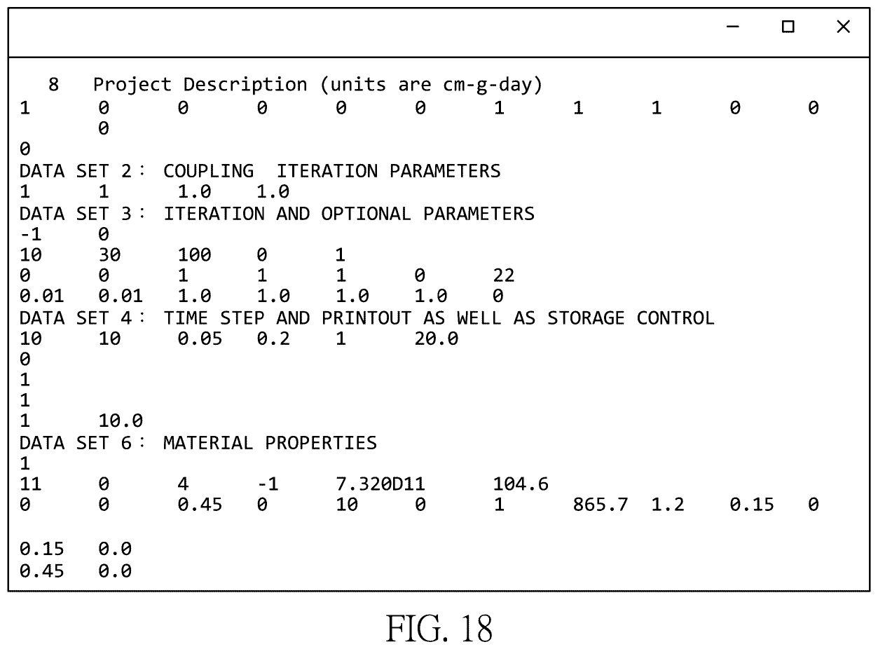

At step S5, the output module 500 may transform the numerical simulation result generated by the computing module 400 for display (such as the displayed simulation result shown in FIGS. 9, 10, 13, 14, 15, 16, and 17) and store the numerical simulation result in a preferred file format. Here, preferred file format for storage, as shown in FIG. 18, may be an ascii file. The storage of numerical simulation result may enable user to inspect the simulation at a later time or use as basis to build other simulations.

Based on the above, the simulation system and simulation method of the present disclosure may accurately simulate complex interactions between fluid movement, thermal transfer, species transfer and reaction and geo-mechanical deformation, thereby enable enhanced understanding and management of subsurface processes such as radioactive waste disposal, CO2 sequestration and/or enhanced geothermal systems in a real-time scenario.

Those skilled in the art will readily observe that numerous modifications and alterations of the embodiments may be made while retaining the teachings of the invention. Accordingly, the above disclosure should be construed as limited only by the metes and bounds of the appended claims.

What is claimed is:

1. A simulation system operating in a computer system, comprising:
an import module configured to import site hydrogeology information of a site;
a mesh setting module coupled with the import module and configured to generate a geometry mesh of an area of interest of the site according to a node configuration and the site hydrogeology information;
a parameter setting module coupled with the mesh setting module and configured to assign a simulation setting parameter for the geometry mesh; and
a computing module coupled with the parameter setting module and configured to compute a numerical simulation result for the area of interest according to the geometry mesh and the simulation setting parameter.

2. The simulation system of claim 1, wherein the simulation setting parameter comprises:
a predetermined time period for simulation;
a number of time steps within the predetermined time period;
a simulation setting of fluid movement under a transient state;
a simulation setting of thermal transfer under the transient state;
a simulation setting of species transfer and reaction under the transient state; and
a simulation setting of geo-mechanical deformation under the transient state.

3. The simulation system of claim 2, wherein the computing module computes the numerical simulation result for the area of interest according to the geometry mesh and the simulation setting parameter comprises:
computing simulation of the fluid movement during a (i)th time step to derive a relationship between mass flux of fluid transferring through porous medium in a domain of the geometry mesh during the (i)th time step, a movement of the fluid within the domain of the geometry mesh during the (i)th time step based on conservation of mass between various phases of the fluid, transport velocity characteristics of the fluid movement during the (i)th time step, and dispersion-diffusion characteristics of the fluid movement during the (i)th time step;
computing simulation of the thermal transfer during the (i)th time step to derive thermal behavior within the domain of the geometry mesh during the (i)th time step based on the transport velocity characteristics of the fluid movement during the (i)th time step and the dispersion-diffusion characteristics of the fluid movement during the (i)th time step;
computing simulation of the species transfer and reaction during the (i)th time step to derive dynamic of concentration change of a specified species during the (i)th time step within the domain of the geometry mesh based on the transport velocity characteristics of the fluid movement during the (i)th time step, the dispersion-diffusion characteristics of the fluid movement during the (i)th time step, and the thermal behavior of the thermal transfer during the (i)th time step;
computing simulation of the geo-mechanical deformation during the (i)th time step to derive displacement and deformation of the medium within the domain of the geometry mesh during the (i)th time step based on the transport velocity characteristics of the fluid movement during the (i)th time step, the dispersion-diffusion characteristics of the fluid movement during the (i)th time step, and the thermal behavior of the thermal transfer during the (i)th time step;
generating feedback from computing simulation of the fluid movement, the thermal transfer, the species transfer and reaction, and the geo-mechanical deformation during the (i)th time step; and
computing the simulation of the fluid movement, the thermal transfer, the species transfer and reaction, and the geo-mechanical deformation within domain of the geometry mesh for a (i+1)th time step according to the feedback.

4. The simulation system of claim 3, wherein the computing module generating the feedback from computing simulation of the fluid movement, the thermal transfer, the species transfer and reaction, and the geo-mechanical deformation during the (i)th time step comprises:
generating the feedback based on the thermal behavior during the (i)th time step to alter fluid viscosity of the fluid in a specified fluid phase and fluid density in the specified fluid phase for simulation of the fluid movement during the (i+1)th time step;
generating the feedback based on the dynamic of concentration change of the specified species during the (i)th time step to consider a production rate of the specified species in the fluid of the specified fluid phase for simulation of the fluid movement during the (i+1)th time step; and
generating the feedback based on the displacement and the deformation of the medium within the domain of the geometry mesh during the (i)th time step to alter dilation of the fluid within the domain of the geometry mesh for simulation of the fluid movement during the (i+1)th time step.

5. The simulation system of claim 3, wherein:
The transport velocity characteristics of the fluid movement during the (i)th time step comprises Darcy velocity of the fluid in a specified fluid phase during the (i)th time step;
the dispersion-diffusion characteristics of the fluid movement during the (i)th time step comprises longitudinal dispersivity of the fluid in the specified fluid phase during the (i)th time step, transverse dispersivity of the fluid in the specified fluid phase during the (i)th time step, hydrodynamic dispersion tensor of the fluid in the specified fluid phase during the (i)th time step, molecular diffusion coefficient of the fluid in the specified fluid phase during the (i)th time step, diffusion coefficient of accumulated normalized-effective saturation of the fluid in the specified fluid phase during the (i)th time step;
the thermal behavior within the domain of the geometry mesh during the (i)th time step is a function associated with thermal conductivity of the medium within the domain of the geometry mesh during the (i)th time step, thermal conductivity of the fluid in the specified fluid phase during the (i)th time step, thermal expansion coefficient of the medium within the domain of the geometry mesh during the (i)th time step, thermal expansion coefficient of the fluid in the specified fluid phase during the (i)th time step, thermal dispersion coefficient tensor of the fluid in the specified fluid phase during the (i)th time step, thermal diffusion coefficient tensor of the fluid in the specified fluid phase during the (i)th time step; and
the displacement and the deformation of the medium within the domain of the geometry mesh during the (i)th time step is a function associated with stress tensor exerting on the medium within the domain of the geometry mesh during the (i)th time step and external force imposing to the medium within the domain of the geometry mesh during the (i)th time step.

6. The simulation system of claim 1, wherein the simulation setting parameter comprises:
a predetermined time period for simulation;
a simulation setting of fluid movement under a steady state;
a simulation setting of thermal transfer under a transient state;
a simulation setting of species transfer and reaction under the transient state; and
a simulation setting of geo-mechanical deformation under the transient state.

7. The simulation system of claim 6, wherein the computing module computes the numerical simulation result for the area of interest according to the geometry mesh and the simulation setting parameter comprises:
computing simulation of the fluid movement during the predetermined time period to derive a relationship between mass flux of fluid transferring through porous medium in a domain of the geometry mesh during the predetermined time period, a movement of the fluid within the domain of the geometry mesh during the predetermined time period based on conservation of mass between various phases of the fluid, transport velocity characteristics of the fluid movement during the predetermined time period, and dispersion-diffusion characteristics of the fluid movement during the predetermined time period;
computing simulation of the thermal transfer during the predetermined time period to derive thermal behavior within the domain of the geometry mesh during the predetermined time period based on the transport velocity characteristics of the fluid movement during the predetermined time period and the dispersion-diffusion characteristics of the fluid movement during the predetermined time period;
computing simulation of the species transfer and reaction during the predetermined time period to derive dynamic of concentration change of a specified species during the predetermined time period within the domain of the geometry mesh based on the transport velocity characteristics of the fluid movement during the predetermined time period, the dispersion-diffusion characteristics of the fluid movement during the predetermined time period, and the thermal behavior of the thermal transfer during the predetermined time period; and
computing simulation of the geo-mechanical deformation during the predetermined time period to derive displacement and deformation of the medium within the domain of the geometry mesh during the predetermined time period based on the transport velocity characteristics of the fluid movement during the predetermined time period, the dispersion-diffusion characteristics of the fluid movement during the predetermined time period, and the thermal behavior of the thermal transfer during the predetermined time period.

8. The simulation system of claim 7, wherein:
the transport velocity characteristics of the fluid movement during the predetermined time period comprises Darcy velocity of the fluid in a specified fluid phase during the predetermined time period;
the dispersion-diffusion characteristics of the fluid movement during the predetermined time period comprises longitudinal dispersivity of the fluid in the specified fluid phase during the predetermined time period, transverse dispersivity of the fluid in the specified fluid phase during the predetermined time period, hydrodynamic dispersion tensor of the fluid in the specified fluid phase during the predetermined time period, molecular diffusion coefficient of the fluid in the specified fluid phase during the predetermined time period, diffusion coefficient of accumulated normalized-effective saturation of the fluid in the specified fluid phase during the predetermined time period;
the thermal behavior within the domain of the geometry mesh during the predetermined time period is a function associated with thermal conductivity of the medium within the domain of the geometry mesh during the predetermined time period, thermal conductivity of the fluid in the specified fluid phase during the predetermined time period, thermal expansion coefficient of the medium within the domain of the geometry mesh during the predetermined time period, thermal expansion coefficient of the fluid in the specified fluid phase during the predetermined time period, thermal dispersion coefficient tensor of the fluid in the specified fluid phase during the predetermined time period, thermal diffusion coefficient tensor of the fluid in the specified fluid phase during the predetermined time period; and
the displacement and the deformation of the medium within the domain of the geometry mesh during the predetermined time period is a function associated with stress tensor exerting on the medium within the domain of the geometry mesh during the predetermined time period and external force imposing to the medium within the domain of the geometry mesh during the predetermined time period.

9. The simulation system of claim 1, wherein the simulation setting parameter comprises:
an initial condition setting defining a starting state of simulation within a domain of the geometry mesh corresponding to the area of interest;
a boundary condition setting defining environmental influences coming frown outside world towards the domain of the geometry mesh corresponding to the area of interest; and
a process coupling setting defining processes of material change within a predetermined time period for simulation within the domain of the geometry mesh.

10. The simulation system of claim 1, further comprising:
an output module coupled with the computing module and configured to transform the numerical simulation result generated by the computing module for display and store the numerical simulation result in a file format.

11. A simulation method, comprising:
an import module importing site hydrogeology information of a site;
a mesh setting module generating a geometry mesh of an area of interest of the site according to a node configuration and the site hydrogeology information;
a parameter setting module assigning a simulation setting parameter for the geometry mesh; and
a computing module computing a numerical simulation result for the area of interest according to the geometry mesh and the simulation setting parameter.

12. The simulation method of claim 11, wherein the simulation setting parameter comprises:
a predetermined time period for simulation;
a number of time steps within the predetermined time period;
a simulation setting of fluid movement under a transient state;
a simulation setting of thermal transfer under the transient state;
a simulation setting of species transfer and reaction under the transient state; and
a simulation setting of geo-mechanical deformation under the transient state.

13. The simulation method of claim 12, wherein the computing module computing the numerical simulation result for the area of interest according to the geometry mesh and the simulation setting parameter comprises:
computing simulation of the fluid movement during a (i)th time step to derive a relationship between mass flux of fluid transferring through porous medium in a domain of the geometry mesh during the (i)th time step, a movement of the fluid within the domain of the geometry mesh during the (i)th time step based on conservation of mass between various phases of the fluid, transport velocity characteristics of the fluid movement during the (i)th time step, and dispersion-diffusion characteristics of the fluid movement during the (i)th time step;
computing simulation of the thermal transfer during the (i)th time step to derive thermal behavior within the domain of the geometry mesh during the (i)th time step based on the transport velocity characteristics of the fluid movement during the (i)th time step and the dispersion-diffusion characteristics of the fluid movement during the (i)th time step;
computing simulation of the species transfer and reaction during the (i)th time step to derive dynamic of concentration change of a specified species during the (i)th time step within the domain of the geometry mesh based on the transport velocity characteristics of the fluid movement during the (i)th time step, the dispersion-diffusion characteristics of the fluid movement during the (i)th time step, and the thermal behavior of the thermal transfer during the (i)th time step;
computing simulation of the geo-mechanical deformation during the (i)th time step to derive displacement and deformation of the medium within the domain of the geometry mesh during the (i)th time step based on the transport velocity characteristics of the fluid movement during the (i)th time step, the dispersion-diffusion characteristics of the fluid movement during the (i)th time step, and the thermal behavior of the thermal transfer during the (i)th time step;
generating feedback from computing simulation of the fluid movement, the thermal transfer, the species transfer and reaction, and the geo-mechanical deformation during the (i)th time step; and
computing the simulation of the fluid movement, the thermal transfer, the species transfer and reaction, and the geo-mechanical deformation within domain of the geometry mesh for a (i+1)th time step according to the feedback.

14. The simulation method of claim 13, wherein the computing module generating the feedback from computing simulation of the fluid movement, the thermal transfer, the species transfer and reaction, and the geo-mechanical deformation during the (i)th time step comprises:
generating the feedback based on the thermal behavior during the (i)th time step to alter fluid viscosity of the fluid in a specified fluid phase and fluid density in the specified fluid phase for simulation of the fluid movement during the (i+1)th time step;
generating the feedback based on the dynamic of concentration change of the specified species during the (i)th time step to consider a production rate of the specified species in the fluid of the specified fluid phase for simulation of the fluid movement during the (i+1)th time step; and
generating the feedback based on the displacement and the deformation of the medium within the domain of the geometry mesh during the (i)th time step to alter dilation of the fluid within the domain of the geometry mesh for simulation of the fluid movement during the (i+1)th time step.

15. The simulation method of claim 13, wherein:
the transport velocity characteristics of the fluid movement during the (i)th time step comprises Darcy velocity of the fluid in a specified fluid phase during the (i)th time step;
the dispersion-diffusion characteristics of the fluid movement during the (i)th time step comprises longitudinal dispersivity of the fluid in the specified fluid phase during the (i)th time step, transverse dispersivity of the fluid in the specified fluid phase during the (i)th time step, hydrodynamic dispersion tensor of the fluid in the specified fluid phase during the (i)th time step, molecular diffusion coefficient of the fluid in the specified fluid phase during the (i)th time step, diffusion coefficient of accumulated normalized-effective saturation of the fluid in the specified fluid phase during the (i)th time step;
the thermal behavior within the domain of the geometry mesh during the (i)th time step is a function associated with thermal conductivity of the medium within the domain of the geometry mesh during the (i)th time step, thermal conductivity of the fluid in the specified fluid phase during the (i)th time step, thermal expansion coefficient of the medium within the domain of the geometry mesh during the (i)th time step, thermal expansion coefficient of the fluid in the specified fluid phase during the (i)th time step, thermal dispersion coefficient tensor of the fluid in the specified fluid phase during the (i)th time step, thermal diffusion coefficient tensor of the fluid in the specified fluid phase during the (i)th time step; and
the displacement and the deformation of the medium within the domain of the geometry mesh during the (i)th time step is a function associated with stress tensor exerting on the medium within the domain of the geometry mesh during the (i)th time step and external force imposing to the medium within the domain of the geometry mesh during the (i)th time step.

16. The simulation method of claim 11, wherein the simulation setting parameter comprises:
a predetermined time period for simulation;
a simulation setting of fluid movement under a steady state;
a simulation setting of thermal transfer under a transient state;
a simulation setting of species transfer and reaction under the transient state; and
a simulation setting of geo-mechanical deformation under the transient state.

17. The simulation method of claim 16, wherein the computing module computing the numerical simulation result for the area of interest according to the geometry mesh and the simulation setting parameter comprises:
computing simulation of the fluid movement during the predetermined time period to derive a relationship between mass flux of fluid transferring through porous medium in a domain of the geometry mesh during the predetermined time period, a movement of the fluid within the domain of the geometry mesh during the predetermined time period based on conservation of mass between various phases of the fluid, transport velocity characteristics of the fluid movement during the predetermined time period, and dispersion-diffusion characteristics of the fluid movement during the predetermined time period;
computing simulation of the thermal transfer during the predetermined time period to derive thermal behavior within the domain of the geometry mesh during the predetermined time period based on the transport velocity characteristics of the fluid movement during the predetermined time period and the dispersion-diffusion characteristics of the fluid movement during the predetermined time period;
computing simulation of the species transfer and reaction during the predetermined time period to derive dynamic of concentration change of a specified species during the predetermined time period within the domain of the geometry mesh based on the transport velocity characteristics of the fluid movement during the predetermined time period, the dispersion-diffusion characteristics of the fluid movement during the predetermined time period, and the thermal behavior of the thermal transfer during the predetermined time period; and
computing simulation of the geo-mechanical deformation during the predetermined time period to derive displacement and deformation of the medium within the domain of the geometry mesh during the predetermined time period based on the transport velocity characteristics of the fluid movement during the predetermined time period, the dispersion-diffusion characteristics of the fluid movement during the predetermined time period, and the thermal behavior of the thermal transfer during the predetermined time period.

18. The simulation method of claim 17, wherein:
the transport velocity characteristics of the fluid movement during the predetermined time period comprises Darcy velocity of the fluid in a specified fluid phase during the predetermined time period;
the dispersion-diffusion characteristics of the fluid movement during the predetermined time period comprises longitudinal dispersivity of the fluid in the specified fluid phase during the predetermined time period, transverse dispersivity of the fluid in the specified fluid phase during the predetermined time period, hydrodynamic dispersion tensor of the fluid in the specified fluid phase during the predetermined time period, molecular diffusion coefficient of the fluid in the specified fluid phase during the predetermined time period, diffusion coefficient of accumulated normalized-effective saturation of the fluid in the specified fluid phase during the predetermined time period;
the thermal behavior within the domain of the geometry mesh during the predetermined time period is a function associated with thermal conductivity of the medium within the domain of the geometry mesh during the predetermined time period, thermal conductivity of the fluid in the specified fluid phase during the predetermined time period, thermal expansion coefficient of the medium within the domain of the geometry mesh during the predetermined time period, thermal expansion coefficient of the fluid in the specified fluid phase during the predetermined time period, thermal dispersion coefficient tensor of the fluid in the specified fluid phase during the predetermined time period, thermal diffusion coefficient tensor of the fluid in the specified fluid phase during the predetermined time period; and
the displacement and the deformation of the medium within the domain of the geometry mesh during the predetermined time period is a function associated with stress tensor exerting on the medium within the domain of the geometry mesh during the predetermined time period and external force imposing to the medium within the domain of the geometry mesh during the predetermined time period.

19. The simulation method of claim 11, wherein the simulation setting parameter comprises:
an initial condition setting defining a starting state of simulation within a domain of the geometry mesh corresponding to the area of interest;
a boundary condition setting defining environmental influences coming frown outside world towards the domain of the geometry mesh corresponding to the area of interest; and
a process coupling setting defining processes of material change within a predetermined time period for simulation within the domain of the geometry mesh.

20. The simulation method of claim 11, further comprising:
an output module transforming the numerical simulation result generated by the computing module for display and store the numerical simulation result in a file format.
